(19) United States
(12) Patent Application Publication
(10) Pub. No.: US 2013/0157202 A1
(43) Pub. Date: Jun. 20, 2013

(54) APPARATUS, METHOD, AND TALBOT INTERFEROMETER FOR CALCULATING ABERRATION OF TEST OPTICAL SYSTEM

(71) Applicant: CANON KABUSHIKI KAISHA, Tokyo (JP)

(72) Inventor: Naoki Kohara, Utsunomiya-shi (JP)

(73) Assignee: CANON KABUSHIKI KAISHA, Tokyo (JP)

(21) Appl. No.: 13/712,502

(22) Filed: Dec. 12, 2012

(30) Foreign Application Priority Data
Dec. 15, 2011 (JP) 2011-275095

(51) Int. Cl. G01B 9/02

(52) U.S. Cl. CPC G01B 9/02038
USPC 430/325; 356/521

(57) ABSTRACT

A calculation apparatus acquires image data of interference fringes detected by using a Talbot interferometer including a diffraction grating and a detector, retrieves a first wavefront by using the image data of the interference fringe, sets a value of a second wavefront incident on the diffraction grating, calculates an interference fringe image of a plurality of the diffracted light beams through simulation, and retrieves a third wavefront by using the calculated interference fringe image, wherein the third wavefront is retrieved by changing a position of the diffraction grating in a plane perpendicular to an optical axis of the Talbot interferometer, and aberration of a test optical system is calculated by reducing an error included in the first wavefront by using the second wavefront and the third wavefront.

### BACKGROUND OF THE INVENTION

1. Field of the Invention

The present invention relates to an apparatus, method, and Talbot interferometer for calculating aberration of a test optical system.

2. Description of the Related Art

A Talbot interferometer is used to measure aberration of a test optical system. FIG. 9 illustrates a conventional Talbot interferometer for measuring aberration of a test optical system L. A mask 200 is illuminated with a light beam of a light source 100, and a light beam transmitting through a pinhole 200a of the mask 200 is incident on the test optical system L. A light beam transmitting through the test optical system L is divided into a plurality of light beams by a diffraction grating 300, and interference fringes formed by interference between the plurality of the light beams is detected by an image pickup device 400. Next, aberration of the test optical system L is calculated by using data of the detected interference fringes.

Herein, the diffraction grating 300 and the image pickup device 400 are disposed to satisfy a Talbot condition. United States Patent Application Publication No. 2010/0177323 or Japanese Patent Application Laid-Open No. 2010-206032 discusses techniques of correcting a measurement error occurring if the above Talbot condition is not satisfied due to deviation of a position of a diffraction grating in an optical axis direction of a Talbot interferometer.

In the inventions discussed in United States Patent Publication Application No. 2010/0177323 or Japanese Patent Application Laid-Open No. 2010-206032, accuracy of measurement is improved by reducing the measurement error occurring due to deviation of the position of the diffraction grating in the optical axis direction of the Talbot interferometer. However, since a measurement error occurring due to the deviation in a position of the diffraction grating in the direction perpendicular to the optical axis direction still exists, measurement cannot be performed with high accuracy.

### SUMMARY OF THE INVENTION

The present invention is directed to an apparatus and a method for calculating aberration of a test optical system.

According to an aspect of the present invention, a calculation apparatus for calculating aberration of a test optical system includes an acquisition unit which acquires image data of interference fringes detected by using a Talbot interferometer including a diffraction grating which divides a light beam incident on the test optical system into a plurality of diffracted light beams and a detector which detects the interference fringes of the plurality of the diffracted light beams, and an operation unit which retrieves a first wavefront by using image data of the interference fringes and which sets a value of a second wavefront incident on the diffraction grating, calculates an interference fringe image of the plurality of the diffracted light beams through simulation, and retrieves a third wavefront by using the calculated interference fringe image, wherein the operation unit retrieves the third wavefront by changing a position of the diffraction grating in a plane perpendicular to an optical axis of the Talbot interferometer to match a phase of a carrier frequency component of the detected interference fringes and a phase of a carrier frequency component of the interference fringe image calculated through the simulation and calculates the aberration of the test optical system by reducing an error included in the first wavefront by using the second wavefront and the third wavefront.

According to another aspect of the present invention, a calculation apparatus for calculating aberration of a test optical system, includes an acquisition unit which acquires image data of interference fringes detected by using a Talbot interferometer including a diffraction grating which divides a light beam incident on the test optical system into a plurality of diffracted light beams and a detector which detects the interference fringes of the plurality of the diffracted light beams, and an operation unit which retrieves a first wavefront by using image data of the interference fringes and which sets a value of a second wavefront incident on the diffraction grating, calculates an interference fringe image of the plurality of the diffracted light beams through simulation, and retrieves a third wavefront by using the calculated interference fringe image, wherein the operation unit retrieves the first wavefront by using image data of the interference fringes detected in a state where a position of the diffraction grating in a plane perpendicular to an optical axis of the Talbot interferometer is adjusted to match a phase of a carrier frequency component of the detected interference fringes and a phase of a carrier frequency component of the interference fringe image calculated through the simulation and calculates the aberration of the test optical system by reducing an error included in the first wavefront by using the second wavefront and the third wavefront.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a diagram illustrating a Talbot interferometer according to a first exemplary embodiment.

FIG. 2 is a flowchart illustrating aberration measurement according to the first exemplary embodiment.

FIG. 3 is a detailed flowchart illustrating S104 of FIG. 2.

FIGS. 4A and 4B are diagrams illustrating Fourier spectrum of the simulated image and Fourier spectrum of the actual interference fringe image.

FIG. 5A is a diagram illustrating supposed wavefront aberration included in a retrieved wavefront Φ1. FIG. 5B is a diagram illustrating a simulated image calculated by setting a wavefront having the wavefront aberration of FIG. 5A as an input wavefront. FIG. 5C is a diagram illustrating a wavefront retrieved from the simulated image of FIG. 5B. FIG. 5D is a diagram illustrating an error occurring due to a position of a diffraction grating. FIG. 5E is a diagram illustrating an error occurring due to a position of the diffraction grating which is estimated again based on a result of FIG. 5D. FIG. 5F is a diagram illustrating a result of measurement of aberration of the test optical system L.

FIG. 6 is a diagram illustrating a Talbot interferometer according to a second exemplary embodiment.

FIG. 7 is a flowchart illustrating aberration measurement according to the second exemplary embodiment.

FIG. 8 is a schematic block diagram illustrating an exposing apparatus.

FIG. 9 illustrates a Talbot interferometer in the related art.

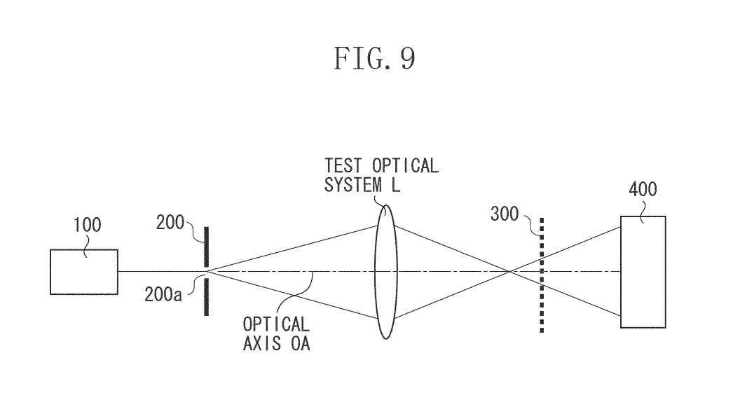

### DESCRIPTION OF THE EMBODIMENTS

Various exemplary embodiments, features, and aspects of the invention will be described in detail below with reference to the drawings.

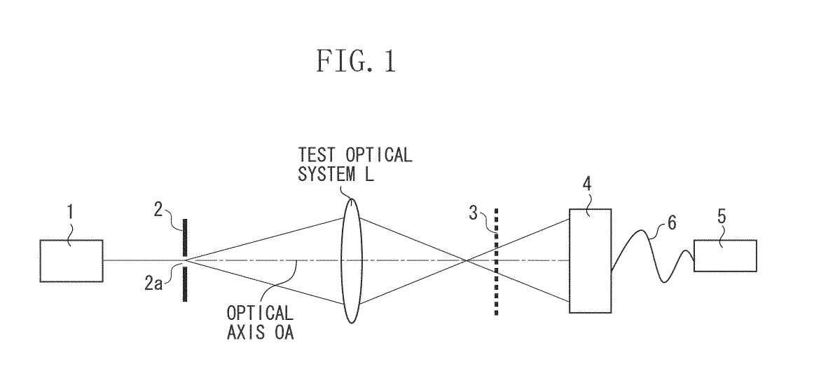

Hereinafter, a first exemplary embodiment will be described. FIG. 1 is a diagram illustrating optical paths of a Talbot interferometer for measuring aberration of a test optical system L. The Talbot interferometer according to the exemplary embodiment includes, along the optical path, a light source 1, a mask 2, a diffraction grating 3, an image pickup device 4 (detector), and a calculator (computer) 5. In the Talbot interferometer, the mask 2 is illuminated with a light beam of the light source 1, and a light beam transmitting through a pinhole 2a of the mask 2 is incident on the test optical system L. A light beam transmitting through the test optical system L is divided into a plurality of diffracted light beams by the diffraction grating 3 and interference fringes formed by interference between the divided light beams is detected by the image pickup device 4. Next, data of the detected interference fringes are transmitted through a cable 6 to the calculator 5, and the calculator 5 calculates aberration of the test optical system L by using the data of the interference fringes. In addition, a wavefront (wavefront aberration) of a light beam emitted from the test optical system L may be calculated as it is. A difference between the wavefront of the light beam incident on the test optical system L and the wavefront of the light beam emitted from the test optical system L is the aberration of the test optical system L.

The light source 1 is configured with, for example, a laser to radiate a coherent light beam. The test optical system L is a plurality of optical elements or one optical element, and the test optical system may be any one of a refraction system, a reflection/refraction system, and a reflection system. In FIG. 1, a lens is illustrated serving as the test optical system L.

The mask 2 is a pinhole plate having the pinhole 2a having a sufficiently small diameter, and a spherical wave is generated by transmitting the light beam of the light source 1 through the pinhole 2a.

The diffraction grating 3 divides the light beam transmitting through the test optical system L into a plurality of diffracted light beams. The diffraction grating 3 is, for example, a perpendicular diffraction grating having grating periods in two perpendicular directions (first and second directions), which divides the light beam transmitting through the test optical system L into a plurality of light beams in the first direction and further divides the light beam into a plurality of light beams in the second direction. Therefore, deformation of wavefront in the two perpendicular directions can be simultaneously measured. However, the above configuration can be adapted to a diffraction grating of which the number of the directions of the grating periods is not 2. In addition, although a diverging light beam is incident on the diffraction grating 3 in FIG. 1, a converging light beam may be used.

The image pickup device 4 is a two-dimensional image pickup device which photographs an interference fringes formed by superposing wavefronts of the plurality of the light beams divided by the diffraction grating 3 (that is, formed by interference between the plurality of the diffracted light beams), and a charge-coupled device (CCD) or the like is used as the image pickup device.

The calculator 5 is connected to the image pickup device 4 through the cable 6 and includes a memory as a storage unit (not illustrated), an acquisition unit, an operation unit, and a display unit. The acquisition unit acquires data of the actual interference fringe image (interference pattern) photographed by the image pickup device 4, through the cable 6. The memory stores the actual interference fringe image photographed by the image pickup device 4 and a simulated interference image obtained through the wave-optical simulation described below.

The operation unit calculates (retrieves) the wavefront from the interference fringes by using a Fourier transform method discussed in, for example, Non-Patent Literature 1, with respect to the actual interference fringe image and the simulated image stored in the memory. The wavefront retrieved in this manner is referred to as a retrieved wavefront. Next, the aberration of the test optical system L is calculated by using data of the retrieved wavefront. The display unit displays the photographed interference fringes or the calculated aberration of the test optical system L.

According to Non-Patent Literature 1, light intensity |u(x, y, z)|² of the interference fringes photographed by the image pickup device 4 can be expressed by the following equation.

$${\vert u ( x , y ; z ) \vert}^{2} = {\sum }_{n = - ∞}^{∞} {\sum }_{m = - ∞}^{∞} {A}_{n} {A}_{m}^{*} exp ( 2 πi \{ ( \frac{{z}_{0}}{{z}_{0} - z} ) ( \frac{n - m}{d} ) [ x - ( \frac{z}{{z}_{0}} ) ( {z}_{0} - z ) ( \frac{\partial W}{\partial x} ) ] - ( \frac{{z}_{0} z}{{z}_{0} - z} ) \frac{( {n}^{2} - {m}^{2} ) λ}{2 {d}^{2}} + \frac{λ}{2} {( \frac{z}{d} )}^{2} ( {n}^{2} - {m}^{2} ) \frac{{\partial }^{2} W}{\partial {x}^{2}} \} ) \qquad ( 1 )$$

Herein, u denotes a complex amplitude of an interference light beam; n and m denote orders of diffracted light beams from the diffraction grating 3; Aₙ denotes an amplitude of an n-th order diffracted light beam; Aₘ denotes an amplitude of an m-th order diffracted light beam; * denotes complex conjugate; z denotes a distance in the optical axis OA direction between the diffraction grating 3 and the image pickup device 4; and z₀ denotes a distance between the diffraction grating 3 and an image plane of the test optical system L. In addition, λ denotes a wavelength of light of a light source; d denotes a pitch (period) of the diffraction grating 3; and W denotes aberration of the test optical system L.

In Equation (1), the second and third phase terms are components which change the contrast of the interference fringes, and a decrease in the contrast is a factor causing a measurement error of the aberration. The third term is a component which always exists and depends on the wavefront. The second term is a component which is periodically changed according to z or z0. The second term becomes 0 by selecting z and z0 so that N expressed by Equation (2) is an integer, and thus, the interference fringes having high contrast can be obtained. The light intensity distribution just after transmitting through the diffraction grating 3 is restored as the interference fringes. When N is a half-integer, the interference fringes having high contrast can be obtained where the phase is shifted by n (that is, light and dark bands are inverted) in comparison with the case where N is an integer.

Therefore, in order to perform the measurement with high accuracy, the diffraction grating 3 and the image pickup device 4 are arranged so that N expressed by Equation 2 is an integer or a half-integer (this condition is referred to as a Talbot condition).

$$( \frac{{z}_{0} z}{{z}_{0} - z} ) \cdot ( \frac{λ}{2 {d}^{2}} ) = N \qquad ( 2 )$$

However, the Talbot condition is based on the presumption that a parallel light beam is incident. Therefore, in the case of a light beam transmitting through the test optical system having large numerical aperture NA (that is, the case where a light beam is incident on the diffraction grating 3 with a large incidence angle), even if the diffraction grating 3 and the image pickup device 4 are arranged to satisfy the Talbot condition, blur occurs in the interference fringes (contrast is decreased). Mainly due to a difference between the phase of the +1st light beam and the phase of the −1st light beam, deviation of the position in the in-plane direction perpendicular to the optical axis of the interferometer occurs in the intensity distribution of the interference fringes having blur. As a result, the retrieved wavefront calculated from the interference fringes inevitably has an error component other than the aberration of the test optical system L.

The error component changes being sensitive to the position of the diffraction grating in the optical axis direction, which determines the Talbot condition. In addition, similarly to the position in the optical axis direction, the error included in the retrieved wavefront also varies due to the position (in-plane position) of the diffraction grating 3 in the plane (in-plane direction) perpendicular to the optical axis of the interferometer.

Therefore, in order to measure the aberration of the test optical system L with high accuracy, the error occurring due to the position of the diffraction grating 3 needs to be correctly estimated. According to the measurement methods discussed in the United States Patent Publication Application No. 2010/0177323 or Japanese Patent Application Laid-Open No. 2010-206032, although the error occurring due to a relative angle or an interval between the image pickup device and the diffraction grating (the position in the optical axis direction) can be reduced, the error occurring due to the in-plane position of the diffraction grating cannot be reduced.

In the exemplary embodiment, the calculator 5 sets various conditions and performs the wave-optical simulation to generate the simulated image of the interference fringes such that the simulation matches the actual interference fringe image obtained by actual photographing with the image pickup device 4. Thus, the error occurring due to the in-plane position of the diffraction grating is obtained.

In the wave-optical simulation, a wavelength is set as an input parameter with respect to the light source 1. With respect to the test optical system L, a position of an image point, numerical aperture and a complex amplitude transmissivity are set. With respect to the diffraction grating 3, a position, a period, and a complex amplitude transmissivity are set, and with respect to the image pickup device 4, a position and a pixel pitch are set as input parameters.

Next, in the wave-optical simulation, a complex amplitude distribution of the light beam just after transmitting through the diffraction grating 3 is calculated according to a distance from the image point of the test optical system L to each point of the diffraction grating 3, and a complex amplitude distribution of the interference light beam at the position of the image pickup device 4 is calculated by using the above complex amplitude distribution.

As a technique for calculating the complex amplitude of the interference light beam at the position of the image pickup device 4 (that is, propagating the complex amplitude of the light beam just next to the diffraction grating 3), for example, a Fresnel-Kirchhoff diffraction integral method, an Angular Spectrum propagation method, and the like are known. The above methods are discussed in “M. Born, E. Wolf, “Principles of Optics 7th (expanded) edition”, 418-425, Pergamon Press (1999)” and “J. W. Goodman, “Introduction to Fourier Optics 3rd edition”, 55-61, Roberts and Company Publishers (2004)”, respectively. The intensity, that is, an absolute square of the calculated complex amplitude distribution is used as the simulated image of the interference fringes which can be obtained through the simulation to correspond to the interference fringes (light intensity distribution) detected by the image pickup device 4.

The retrieved wavefront calculated based on the actual interference fringe image is denoted by Φ1 (first wavefront). In the wave-optical simulation, the wavefront of the light beam which transmits through the test optical system L and is not yet incident on the diffraction grating 3 is denoted by an input wavefront Φ2 (second wavefront). The retrieved wavefront (output wavefront) calculated based on the simulated image is denoted by Φ3 (third wavefront).

Φ1 includes an error occurring due to the position of the diffraction grating 3 in addition to the aberration of the test optical system. In addition, in the simulation, a difference (Φ3−Φ2) between Φ3 and Φ2 is an error occurring due to the position of the diffraction grating 3. If the value of Φ3−Φ2 is equal to the value of the error actually occurring due to the diffraction grating 3 in the Talbot interferometer, the aberration Φ of the test optical system can be calculated by removing the error other than the aberration of the test optical system (the error occurring due to the position of the diffraction grating) from the retrieved wavefront Φ1.

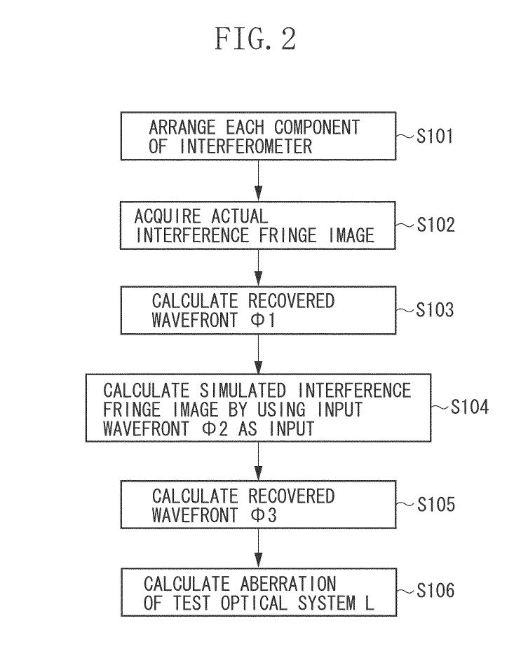

FIG. 2 is a flowchart illustrating aberration measurement according to the first exemplary embodiment.

First, in step S101, in an actual Talbot interferometer, components (the light source 1, the pinhole 2a, the test optical system L, the diffraction grating 3, and the image pickup device 4) are disposed so that the interference fringes satisfying the Talbot condition has high contrast. Next, in step S102, the interference fringes is detected by the image pickup device 4, and the acquisition unit of the calculator 5 acquires the image data of the detected interference fringes. Next, in step S103, the operation unit of the calculator 5 calculates the retrieved wavefront Φ1 by using the image data of the interference fringes acquired in S102. Next, in step S104, in the wave-optical simulation, the calculator 5 calculates a simulated image of the interference fringes by using the values of the input parameters and the value of the input wavefront Φ2 as input values. The details of calculating an interference fringe image from simulation, at step S104, will be described below.

After the retrieved wavefront Φ3 is calculated from the simulated image in step S105, the aberration Φ of the test optical system is calculated by removing the errors other than the aberration of the test optical system from the retrieved wavefront Φ1. More specifically, in step S106, the calculation process for calculating Φ1−(Φ3−Φ2), Φ1+Φ2−Φ3, and the like is performed, and the wavefront (wavefront aberration) calculated through the calculation process is displayed on the display unit of the calculator 5 as the aberration of the test optical system L.

In addition, in 5104, as the initial value of the input wavefront Φ2, when the aberration of the test optical system L is small and the deformation of the interference fringes is small, the value of the input wavefront Φ2 may be used as the wavefront having aberration of zero. When the aberration of the test optical system L is large, it is advantageous to set the retrieved wavefront Φ1 based on the actual interference fringe image as the input wavefront Φ2 of the wave-optical simulation. The reason is as follows. The more equivalent the retrieved wavefront Φ1 based on the actual interference fringe image is to the retrieved wavefront Φ3 based on the simulated image, with the higher accuracy, the error occurring due to the position of the diffraction grating can be estimated.

Since the error occurring due to the position of the diffraction grating is generally smaller than that of the wavefront Φ1 having the aberration of the test optical system L, if Φ1 is used as the initial value of the input wavefront Φ2, the result of Φ3 becomes approximate to Φ1. In addition, the operation of performing the wave-optical simulation (S104, S105) by using the calculated value of the aberration of the test optical system L as a new value of the input wavefront Φ2 may be repetitively (iteratively) performed until the error occurring due to the position of the diffraction grating converges to a certain value.

The wave-optical simulation of S104 needs to be performed so that the simulated fringe image and the actual interference fringe image obtained by actual photographing match with each other in terms of the carrier frequency and the phase of the carrier frequency component. Particularly, since the position of the diffraction grating 3 sensitively influences the carrier frequency and the phase of the carrier frequency, adjustment of the position of the diffraction grating 3 input in the simulation is performed.

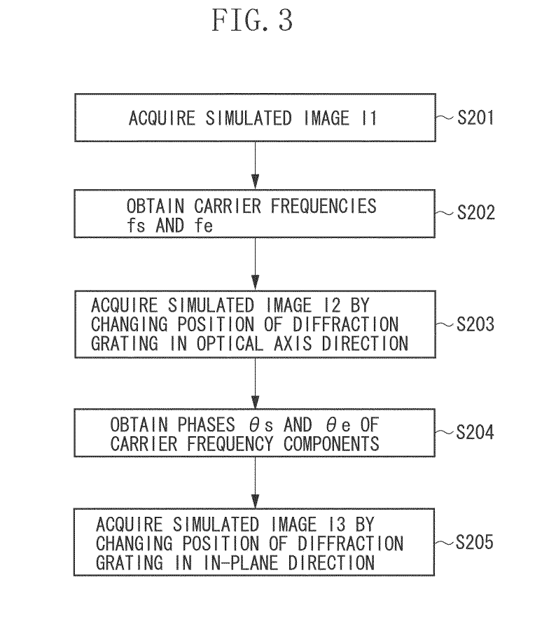

FIG. 3 is a flowchart illustrating an example of a procedure of matching the simulated image and the actual interference fringe image obtained by actual photographing with each other in terms of the carrier frequency and the phase of the carrier frequency component in S104.

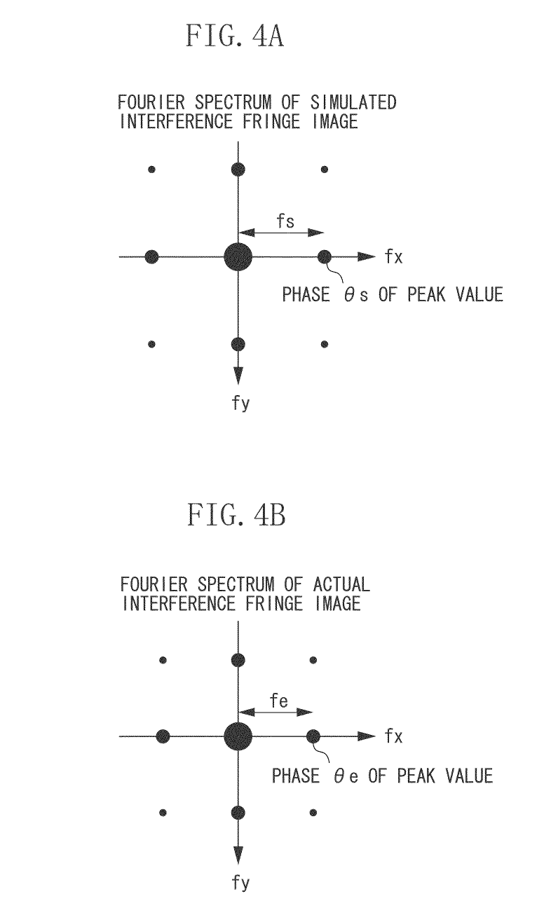

First, in step S201, the input parameters are set, and the wave-optical simulation is performed, so that the simulated image I1 of the interference fringes is obtained. Next, in step S202, the carrier frequency fs of the simulated image I1 and the carrier frequency fe of the actual interference fringe image obtained by actual photographing are obtained. The carrier frequency indicates a position (frequency) at an amplitude peak corresponding to the period of the interference pattern in the spatial frequency spectrum obtained by performing Fourier transform on each image. FIGS. 4A and 4B illustrate the relation of the carrier frequency fs of the simulated fringe image and the relation of the carrier frequency fe of the actual interference fringe image obtained by actual photographing in the frequency space, respectively. Herein, fs and fe may be expressed by the following equations.

$${f}_{s} = \frac{2 {z}_{s} tan ( {sin}^{- 1} NA )}{d} \\ {f}_{e} = \frac{2 {z}_{e} tan ( {sin}^{- 1} NA )}{d} \qquad ( 3 )$$

Zs denotes an interval between the image plane of the test optical system L and the diffraction grating 3 set in the simulation; Ze denotes an interval between the image plane of the test optical system L and the diffraction grating 3 during the photographing; d denotes a period of the diffraction grating 3; and NA denotes a numerical aperture of an image side of the test optical system L.

Considering the relation of the carrier frequencies illustrated in FIG. 4, in order to cause the carrier frequency of the simulated image to match the carrier frequency of the actual interference fringe image, the position of the diffraction grating 3 in the optical axis direction, which is input in the simulation, is moved by Zs·(fe−fs)/fs in a direction away from the image plane. The position of the diffraction grating 3 in the optical axis direction is changed and the wave-optical simulation is performed again, so that in step S203 a new simulated image I2 is obtained.

In the case of using a two-dimensional diffraction grating, because of alignment of the apparatus, deviation may occur in the two carrier frequency directions of the interference fringe image. In this case, the carrier frequency in the wave-optical simulation and the average value of carrier frequencies of two directions may be matched with each other, or a relative slope between the diffraction grating and the image pickup device may be introduced in the wave-optical simulation. If there is no difference between fe and fs calculated in S202, S203 needs not to be performed.

Next, in step S204, the phase θs of the carrier frequency component of the simulated image I2 and the phase θe of the carrier frequency component of the actual interference fringe image obtained by actual photographing are acquired. As illustrated in FIG. 4, the phase of the carrier frequency component is a phase (unit: radian) at an amplitude peak corresponding to a period of an interference pattern in a spatial frequency spectrum. In other words, the phase of the carrier frequency component indicates an initial phase where the interference pattern is regarded as a sinusoidal wave having the carrier frequency.

The mismatch between θs and θe occurs due to the in-plane position of the diffraction grating (the position in the direction perpendicular to the optical axis of the interferometer) set in the simulation. Therefore, the mismatch can be solved by moving the in-plane position of the diffraction grating input in the simulation by d·(θe−θs)/(2π) in the direction of the carrier frequency. In the case of using a two-dimensional diffraction grating, the in-plane position is adjusted in the two carrier frequency directions. In an arrangement where the in-plane position of the diffraction grating is changed, the wave-optical simulation is performed again, so that in step S205 a new simulated image I3 is obtained. The obtained simulated image I3 is turned over to the calculation of S105.

When a change in the carrier frequency is small in S203, S203 and S205 may be simultaneously performed. In this case, since the carrier frequency and the phase of the carrier frequency are simultaneously adjusted, the simulated image I2 needs not to be obtained.

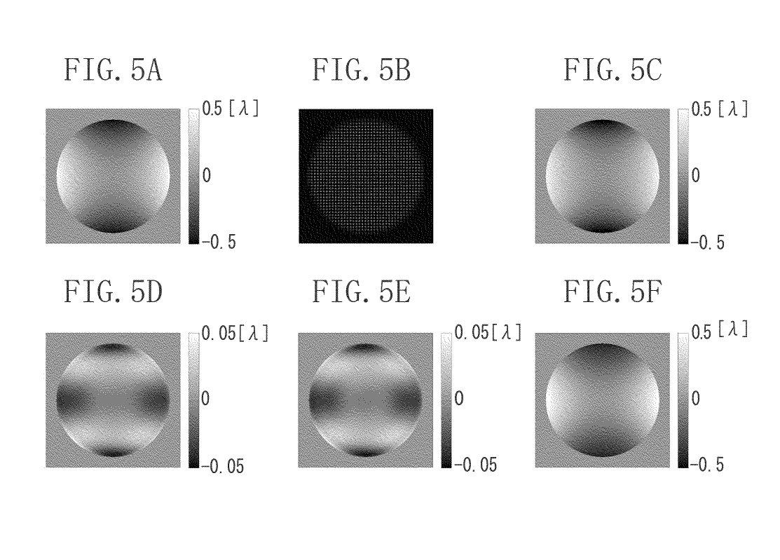

A specific example of the aberration measurement method according to the exemplary embodiment will be described with reference to simulation results illustrated in FIGS. 5A to 5F. The mask 2 is illuminated with an illumination light beam of NA 0.25 by using an extreme ultraviolet (EUV) light beam having a wavelength of 0.0135 micrometers emitted from a light source. The diffraction grating 3 is a two-dimensional grating which performs amplitude modulation with a period of 1 micrometer. In order to obtain an interference pattern having Talbot order of 0.5, the point light source of the image plane of the test optical system L is disposed at the position 74.1 μm upstream of the diffraction grating 3, and an interval between the point light source and the image pickup device 4 is set to 10 mm.

FIG. 5A illustrates a wavefront aberration which is assumed as a retrieved wavefront Φ1 based on the actual interference fringe image obtained by actual photographing. This is a wavefront aberration obtained by setting Fringe Zernike coefficient fifth term (astigmatism) of 0.5λ (2.756 nmRMS) as a wavefront aberration of the test optical system L, performing wave-optical simulation and wavefront retrieving based on the wavefront, and adding the error to the wavefront aberration of the test optical system L.

FIG. 5B illustrates a simulated image of the interference fringe pattern obtained through the wave-optical simulation when the wavefront having wavefront aberration of FIG. 5A is set as an initial value of the input wavefront Φ2, using the aberration measurement method according to the exemplary embodiment. FIG. 5C illustrates aberration (2.700 nmRMS) of the retrieved wavefront Φ3 calculated from the simulated image illustrated in FIG. 5B. FIG. 5D illustrates a value (error occurring due to the position of the diffraction grating) obtained by subtracting the retrieved wavefront Φ2 from the retrieved wavefront Φ3, which is 0.24 nmRMS.

FIG. 5E illustrates an error occurring due to the position of the diffraction grating which is estimated again by setting the wavefront obtained by subtracting the value of FIG. 5D from the retrieved wavefront Φ1, as a new value of the input wavefront Φ2 and performing the wave-optical simulation (S104, S105) again. A difference between the value of FIG. 5E and the value of FIG. 5D is 0.01 nmRMS. If the new value of the input wavefront Φ2 is set by using the value of FIG. 5E and the same wave-optical simulation is performed again, the difference between the retrieved wavefronts Φ3 and Φ1 becomes 0.01 nmRMS or less. Therefore, the value of the error occurring due to the position of the diffraction grating is obtained with accuracy of 0.01 nmRMS or less error.

FIG. 5F illustrates aberration (2.757 nmRMS) of the wavefront obtained by subtracting the value of FIG. 5E from the retrieved wavefront Φ1. This wavefront corresponds to aberration of the wavefront of the light beam emitted from the test optical system L, in other words, aberration from which an error is removed. The error occurring due to the position of the diffraction grating is removed with accuracy of 0.01 nmRMS or less. Since the error of about 0.2 nmRMS occurs due to the position of the diffraction grating, the exemplary embodiment can be effectively adapted to the case of obtaining the aberration of the test optical system with accuracy of 0.2 nmRMS or less error.

In this manner, according to the exemplary embodiment, the error occurring due to an in-plane position of the diffraction grating is reduced, so that it is possible to calculate the aberration of the test optical system L with high accuracy.

In a second exemplary embodiment, a position of a diffraction grating 3 of a Talbot interferometer is adjusted so that a simulated image prepared through the wave-optical simulation matches an actual interference fringe image obtained by actual photographing in terms of a carrier frequency and a phase of the carrier frequency component.

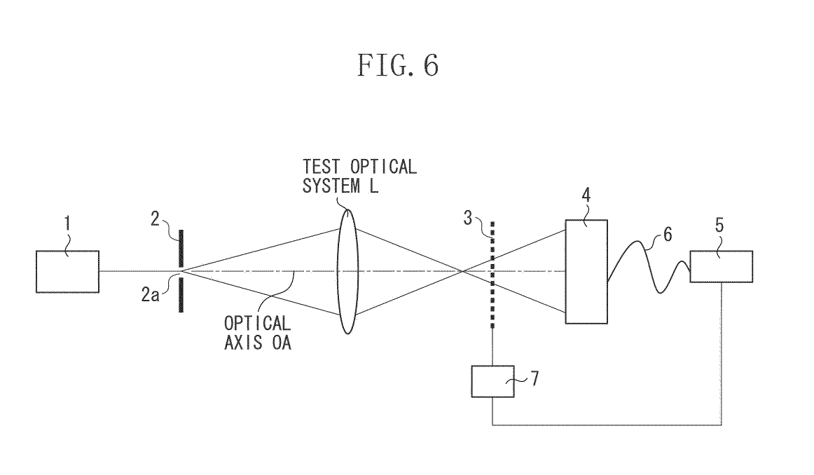

FIG. 6 is a diagram illustrating an optical path of a Talbot interferometer for measuring aberration of a test optical system L according to the second exemplary embodiment. The Talbot interferometer according to the exemplary embodiment includes a moving mechanism 7 which moves the diffraction grating 3 in an optical axis OA direction of the interferometer and a direction perpendicular to the optical axis OA direction (in-plane direction of the diffraction grating 3).

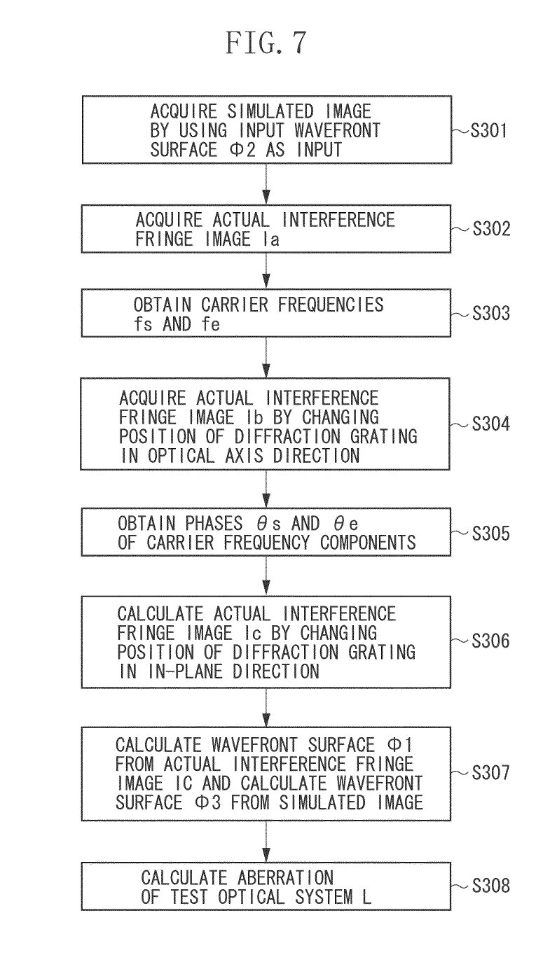

FIG. 7 is a flowchart illustrating aberration measurement according to the second exemplary embodiment.

First, in the wave-optical simulation, the positions of optical elements (the test optical system L, the diffraction grating 3, the image pickup device 4, and the like) are set so that the interference fringe satisfying the Talbot condition has high contrast. Next, in step S301, the wave-optical simulation is performed to obtain the simulated image of the interference fringes (or interference fringe pattern). The initial value of the aberration of the input wavefront Φ2 of the wave-optical simulation is set to an estimated value based on design of the test optical system L or zero.

Next, in the actual interferometer, optical elements are disposed at the position set through the simulation. In step S302, the actual interference fringe image Ia is detected by using the image pickup device 4, and the acquisition unit of the calculator 5 acquires the image data. In step S303, the operation unit of the calculator 5 calculates the carrier frequency fs from the simulated image acquired in S301 and calculates the carrier frequency fe from the actual interference fringe image Ia acquired in S302.

Subsequently, in step S304, the position of the diffraction grating 3 in the optical axis direction of the interferometer is separated from the image plane by Zs·(fs−fe)/fs using the moving mechanism 7. After that, the actual interference fringe image Ib is obtained by the image pickup device 4. If there is no difference between fe and fs calculated in S303, S304 needs not to be performed.

In step S305, the operation unit of the calculator 5 calculates the phase θs of the carrier frequency component from the simulated image and calculates the phase θe of the carrier frequency component from the actual interference fringe image Ib. Subsequently, in step S306, in the state where the in-plane position of the diffraction grating 3 is moved by d·(θs−θe)/(2π) in the direction of the carrier frequency using the moving mechanism 7, the actual interference fringe image Ic is photographed by the image pickup device 4.

In step S307, the operation unit of the calculator calculates the retrieved wavefront Φ1 based on the actual interference fringe image Ic and calculates the retrieved wavefront Φ3 based on the simulated image. After that, the operation unit of the calculator calculates the aberration Φ of the test optical system by removing the error other than the aberration of the test optical system from the retrieved wavefront Φ1. More specifically, the calculation process for calculating Φ1−(Φ3−Φ2) or the like is performed. Next, in step S308, the wavefront obtained through the calculation process is displayed on the display unit of the calculator 5 as the aberration of the test optical system L.

If Φ2 is greatly separated from Φ3 obtained through the performing of the flowchart of FIG. 7, S104, S105, and S106 of FIG. 2 are further performed after S306, so that it is possible to improve accuracy of calculation of aberration.

In addition, the aberration of the test optical system L which is previously obtained may be set as a new value of the input wavefront Φ2, and S301 to S308 are repetitively performed, so that the accuracy of calculation of the aberration of the test optical system L may be improved.

According to the exemplary embodiment, it is possible to measure the aberration of the test optical system with high accuracy by reducing the error occurring due to an in-plane position of the diffraction grating.

In addition, the first and second exemplary embodiments may be combined and performed.

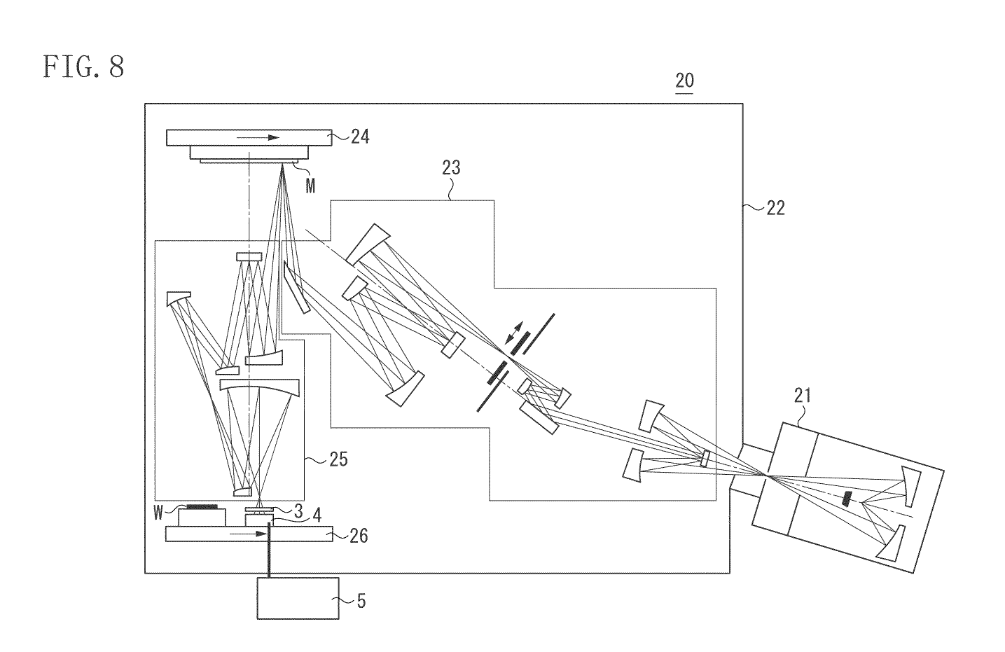

Hereinafter, a third exemplary embodiment will be described. FIG. 8 is a schematic block diagram illustrating an exposing apparatus 20 having a Talbot interferometer.

The exposing apparatus 20 is a projection exposing apparatus which projects an image of a pattern of a master on a substrate by using a light beam of a light source unit 21 to expose the substrate. An illumination optical system 23, a master stage 24, a projection optical system 25, a substrate stage 26, and a portion of the Talbot interferometer are installed in a vacuum chamber 22.

The light source unit 21 is a light source oscillating an EUV light beam having a wavelength of about 13.5 nm. Since the EUV light beam has low transmissivity with respect to atmosphere, main optical systems are included within the vacuum chamber 22. The illumination optical system 23 is an optical system which allows the EUV light beam to propagate and illuminates the master (mask or reticle) M. The illumination optical system 23 also has a function as an illumination optical system of the Talbot interferometer or a mask 2. A pinhole plate is disposed in the vicinity of the master M.

The master M is a reflection type master, and the pattern which is turned over to the substrate is formed thereon. The master M is supported and driven by the master stage 24. The projection optical system 25 is a reflection type optical system which projects the image of the pattern of the master M on the substrate W and maintains the two components in an optically conjugate state. The projection optical system 25 is a test optical system L measured by the Talbot interferometer, and the test optical system L may not be necessarily a refraction optical system as described in the exemplary embodiment. The substrate W is coated with a photosensitive material and is supported and driven by the substrate stage 26.

The Talbot interferometer measures the aberration of the projection optical system 25. Although the diffraction grating 3 and the image pickup device 4 of the Talbot interferometer are mounted on the substrate stage 26, the diffraction grating 3 and the image pickup device 4 may be arranged on an independent measurement stage. The diffraction grating 3 and the image pickup device 4 can be moved in the optical axis direction of the projection optical system 25 and the direction perpendicular to the optical axis by a moving unit (not illustrated) installed in the substrate stage 26.

In an exposing operation, the master M is illuminated with the light beam of the light source unit 21 through the illumination optical system 23. The diffracted light beam of the master M is projected on the substrate W by the projection optical system 25. Since the Talbot interferometer is mounted on the exposing apparatus 20 to measure the aberration of the projection optical system 25, the aberration of the projection optical system 25 and an aging change can be corrected, so that it is possible to improve exposing accuracy.

Next, a method for manufacturing a device (a semiconductor device, a liquid crystal display device, or the like) according to an exemplary embodiment of the present invention will be described. The semiconductor device is manufactured through a pre-process for forming integrated circuits on a substrate such as a wafer and a post-process for completing a product such as a semiconductor chip including the integrated circuits formed on the substrate in the pre-process. The pre-process includes a process for exposing a substrate coated with a sensitive material by using the above-described exposing apparatus and a process for developing the substrate.

The post-process includes an assembly process (dicing, bonding) and a packaging process (sealing). The liquid crystal display device is manufactured through a process for forming transparent electrodes. The process for forming the transparent electrodes includes a process for coating a substrate such as a glass substrate, on which a transparent conductive film is deposited, with a photosensitive material, a process for exposing the substrate coated with the photosensitive material by using the above-described exposing apparatus, and a process for developing the substrate. By the method for manufacturing a device according to the exemplary embodiment, it is possible to manufacture a device having a higher quality than conventional art.

### Other Embodiments

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-275095 filed Dec. 15, 2011, which is hereby incorporated by reference herein in its entirety.

### LIST OF CITED REFERENCES

Non-Patent Literature 1: “M. Born, E. Wolf, “Principles of Optics 7th (expanded) edition”, 418-425, Pergamon Press (1999)”;
Patent Literature 1: United States Patent Publication Application No. 2010/0177323; and
Patent Literature 2: Japanese Patent Application Laid-Open No. 2010-206032

What is claimed is:

1. A calculation apparatus for calculating aberration of a test optical system, comprising:
an acquisition unit which acquires image data of interference fringes detected by using a Talbot interferometer including a diffraction grating which divides a light beam incident on the test optical system into a plurality of diffracted light beams and a detector which detects the interference fringes of the plurality of the diffracted light beams; and
an operation unit which retrieves a first wavefront by using the image data of the interference fringes and which sets a value of a second wavefront incident on the diffraction grating, calculates an interference fringe image of the plurality of the diffracted light beams through simulation, and retrieves a third wavefront by using the calculated interference fringe image,
wherein the operation unit retrieves the third wavefront by changing a position of the diffraction grating in a plane perpendicular to an optical axis of the Talbot interferometer to match a phase of a carrier frequency component of the detected interference fringes with a phase of a carrier frequency component of the interference fringe image calculated through the simulation, and calculates the aberration of the test optical system by reducing an error included in the first wavefront by using the second wavefront and the third wavefront.

2. The calculation apparatus according to claim 1, wherein the operation unit retrieves the third wavefront by moving the diffraction grating by d·(θs−θe)/2π in an in-plane direction, where the phase of the carrier frequency component of the detected interference fringes is denoted by θe, the phase of the carrier frequency component of the interference fringe image calculated through the simulation is denoted by θe, and a pitch of the diffraction grating is denoted by d.

3. The calculation apparatus according to claim 1, wherein the operation unit sets a wavefront obtained by removing a wavefront, which is obtained by subtracting the second wavefront from the third wavefront, from the first wavefront as a new value of the second wavefront incident on the diffraction grating, calculates the interference fringe image of the plurality of diffracted light beams through simulation, and repeats a process for retrieving a new third wavefront by using the calculated image of the interference fringes.

4. A calculation apparatus for calculating aberration of a test optical system, comprising:
an acquisition unit which acquires image data of interference fringes detected by using a Talbot interferometer including a diffraction grating which divides a light beam incident on the test optical system into a plurality of diffracted light beams and a detector which detects the interference fringes of the plurality of the diffracted light beams; and
an operation unit which retrieves a first wavefront by using image data of the interference fringes and which sets a value of a second wavefront incident on the diffraction grating, calculates an interference fringe image of the plurality of the diffracted light beams through simulation, and retrieves a third wavefront by using the calculated image of the interference fringes,
wherein the operation unit retrieves the first wavefront by using the image data of the interference fringes detected in a state where a position of the diffraction grating in a plane perpendicular to an optical axis of the Talbot interferometer is adjusted to match a phase of a carrier frequency component of the detected interference fringes with a phase of a carrier frequency component of the interference fringe image calculated through the simulation and calculates the aberration of the test optical system by reducing an error included in the first wavefront by using the second wavefront and the third wavefront.

5. A Talbot interferometer comprising:
the calculation apparatus according to claim 1;
a diffraction grating which divides a light beam transmitting through a test optical system into a plurality of diffracted light beams; and
a detector which detects the interference fringes of the plurality of the diffracted light beams.

6. A Talbot interferometer comprising:
the calculation apparatus according to claim 4;
a diffraction grating which divides a light beam transmitting through a test optical system into a plurality of diffracted light beams; and
a detector which detects the interference fringes of the plurality of the diffracted light beams.

7. A calculation method for calculating aberration of a test optical system, comprising:
acquiring image data of interference fringes detected by using a Talbot interferometer including a diffraction grating which divides a light beam incident on the test optical system into a plurality of diffracted light beams and a detector which detects the interference fringes of the plurality of the diffracted light beams; and
retrieving a first wavefront by using image data of the interference fringes;
performing simulation in which a value of a second wavefront incident on the diffraction grating is set, an image of the interference fringes of the plurality of the diffracted light beams is calculated through simulation, and a third wavefront is retrieved by using the calculated image of the interference fringes; and
calculating the aberration of the test optical system by reducing an error included in the first wavefront by using the second wavefront and the third wavefront,
wherein in the simulation, the third wavefront is retrieved by changing a position of the diffraction grating in a plane perpendicular to an optical axis of the Talbot interferometer to match a phase of a carrier frequency component of the detected interference fringes with a phase of a carrier frequency component of the image of the interference fringes calculated through the simulation.

8. A calculation method for calculating aberration of a test optical system, comprising:
acquiring image data of interference fringe detected by using a Talbot interferometer including a diffraction grating which divides a light beam of the test optical system into a plurality of diffracted light beams and a detector which detects the interference fringe of the plurality of the diffracted light beams; and
retrieving a first wavefront by using image data of the interference fringe;
performing simulation in which a value of a second wavefront incident on the diffraction grating is set, an interference fringe image of the plurality of the diffracted light beams is calculated through simulation, and a third wavefront is retrieved by using the calculated image of the interference fringe; and
calculating the aberration of the test optical system by reducing an error included in the first wavefront by using the second wavefront and the third wavefront,
wherein in the retrieving of the first wavefront, the first wavefront is retrieved by using the image data of the interference fringe detected in a state where a position of the diffraction grating in a plane perpendicular to an optical axis of the Talbot interferometer is adjusted to match a phase of a carrier frequency component of the detected interference fringe with a phase of a carrier frequency component of the interference fringe calculated through the simulation.

9. An exposing apparatus for exposing a substrate by using a projection optical system comprising:
a Talbot interferometer; and
the calculation apparatus according to claim 1,
wherein the calculation apparatus calculates aberration of the projection optical system.

10. An exposing apparatus for exposing a substrate by using a projection optical system comprising:
a Talbot interferometer; and
the calculation apparatus according to claim 4,
wherein the calculation apparatus calculates aberration of the projection optical system.

11. A device manufacturing method comprising:
exposing a substrate by using the exposing apparatus according to claim 9; and
developing the exposed substrate.

12. A device manufacturing method comprising:
exposing a substrate by using the exposing apparatus according to claim 10; and
developing the exposed substrate.
